(19) United States
(12) Patent Application Publication
(10) Pub. No.: US 2024/0090977 A1
(43) Pub. Date: Mar. 21, 2024

(54) ORTHODONTIC ALIGNER COMPRISING BITE PLATE

(71) Applicant: Maria Olinta Zurita Dehó, São Paulo (BR)

(72) Inventor: Maria Olinta Zurita Dehó, São Paulo (BR)

(21) Appl. No.: 18/341,919

(22) Filed: Jun. 27, 2023

(30) Foreign Application Priority Data
Sep. 19, 2022 (BR) 102022018785-1

(51) Int. Cl. A61C 7/08

(52) U.S. Cl. CPC A61C 7/08

(57) ABSTRACT

The present application refers to an orthodontic aligner comprising a material that results in one side being flat and the other having the shape of teeth, or the two sides being flat. This type of contact causes dememorization of the occlusal contacts, causing relaxation. Thus, the principles of the conventional bite plate are used. In addition, people who have joint problems or pain (TMJ) or muscle pain (temporalis, masseter muscles) can use the devices without worsening the condition and with better results and pain relief. As well as patients without muscle and joint symptoms can also use the device more comfortably.

### CROSS-REFERENCE TO RELATED APPLICATION

This application claims the benefit of and priority to Brazil Patent Application No. 102022018785-1 filed Sep. 19, 2022, the contents of which being incorporated by reference in its entirety herein.

### TECHNICAL FIELD

The present disclosure relates to an aligner for orthodontic treatments that includes a bite plate. Orthodontic aligners are transparent plates made by copying the shape of the teeth, which consist in plates made of different materials (that may vary depending on the brand) placed over the teeth to change their position. These aligners make the occlusion (the touch of the teeth when the mouth is closed) uncomfortable. It often causes clenching stimulus, and the person keeps non-stop clenching the teeth, causing pain and discomfort. The aligner object of the present application comprises an element that leaves one of the arches flat (principle of the bite plate in which this artifice causes muscle relaxation) and the other with the shape of teeth, or the two flat sides. This type of contact causes a dememorization of the occlusal contacts, resulting in muscle relaxation.

### BACKGROUND

The use of aligners for orthodontic treatments represented an evolution in this type of treatment. The aligners are acetate, polyurethane, smart track plates (trademark by Invisialign), which replicate the shape of the teeth, applying small pressure on one side or the other of the teeth, resulting in a change of position.

Teeth clenching can cause discomfort, muscle pain, and even dental intrusion (the tooth sinks in relation to the dental alveolus, deviating the occlusion. This pressure can cause wear and softening of the teeth. In more severe cases, bone problems may also occur in the gum and jaw joint (TMJ). Possibly, the dysfunction is linked to genetic factors, situations of stress, tension, anxiety, or physical problems of occlusion or inadequate closure of the mouth, for example.

The temporomandibular joint (TMJ) is a complex joint that connects the mandible to the temporal bones of the skull.

These joints allow movement of the jaw up and down and from side to side, which facilitates speech, chewing, yawning, and more.

The use of orthodontic aligners can cause muscle disorders, causing continuous tightening.

Document U.S. Ser. No. 10/952,821 discloses systems, devices, and methods for simultaneously treating temporomandibular joint dysfunction (TMD) and teeth with orthodontic movement. The devices taught in this document can have an orthodontic aligner and a TMD treatment appliance. The devices can be configured to simultaneously reposition a mandible and orthodontically move one or more teeth. Usually, this device is used in diagnostics.

Document EP3984497 discloses a device for aligning teeth comprising a mouthpiece (orthodontic aligner), wherein the mouthpiece is to be placed within an oral cavity to cover the teeth and manufactured by an additive manufacturing device, the method including carrying out manufacturing additive for producing a manufactured product comprising the mouthpiece (orthodontic aligner), a peripheral portion connected to the mouthpiece (orthodontic aligner), and a bracket configured to support the peripheral portion.

Therefore, the state of the art lacks treatment solutions in which an orthodontic aligner that simultaneously moves the teeth and provides TMJ relief based on the memory of the occlusal contacts.

### BRIEF SUMMARY

An aspect of the present application consists of an orthodontic aligner that has the objective of moving the teeth, with inclination, proclination, lingualization, among others, performing the orthodontic function, but will also have the function of muscle relaxation. Thus, the patient feels comfort and relief of muscle symptoms with the use of the aligner, and also has the correction of orthodontic problems. This becomes possible thanks to the change in the occlusal plane of the aligners, where, in one of the arches, it will be a completely flat platform and in the other it will continue in the same way, copying the outline of the teeth, where the contacts with the antagonist teeth will be made with the tip of cusp on flat platform. This type of contact causes a dememorization of the occlusal contacts, causing muscle relaxation.

As such, the principles of the conventional bite plate are used. Furthermore, people who have TMJ or muscle problems (temporalis, masseter muscles) can use the devices in accordance with this application without worsening the condition and with better results and pain relief. In an additional modality, there are two flat arcades where one slides over the other.

### BRIEF DESCRIPTION OF THE DRAWINGS

The drawings that accompany this disclosure are exemplary and non-limiting modalities. Similar reference numerals indicate identical or functionally equivalent elements throughout, where:

FIG. 1 illustrates a first embodiment of the bite plates included in the orthodontic aligner according to the present application; this can be on the upper arch as in the photo or the other way around, on the lower one;

FIG. 2 illustrates the aligner plate with the plate or in the upper or lower arch; and

FIG. 3 illustrates an embodiment of the bite plates included in the orthodontic aligner according to the present application, where the two aligners are used together.

### DETAILED DESCRIPTION

Various embodiments are described herein for a device that consists of an orthodontic aligner (1) where, in one of the arches, the occlusal plane is flat (3) and the other with the shape of the teeth (2), or the two flat sides. This type of contact causes a dememorization of the occlusal contacts, causing relaxation. Thus, the principles of the conventional bite plate are used. In addition, people who have joint problems or pain (TMJ) or muscle pain (temporalis, masseter muscles) can use the devices without worsening the condition and with better results and pain relief.

The aligner (1) according to the present application comprises additional material, which leaves one side of the combined aligner flat (3) and the other in the shape of the teeth (2). In an additional embodiment, the combined aligner has one or both flat sides (3).

This conformation allows a type of contact that causes a dememorization of the occlusal contacts, causing relaxation.

In this way, the aligner (1) combined according to the present application makes concomitant use of the traditional orthodontic alignment of the teeth with the principles of the conventional bite plate, causing a relaxation of the masseter and temporalis muscles, etc., with forgetting the occlusal contacts.

In the aligner according to the current model, wearers or users may experience discomfort and may keep squeezing the plates together. The aligner according to the present application allows for better comfort, despite maintaining the effect of an orthodontic appliance.

Users who suffer from TMJ pain, bruxism, clenching, can use the aligner in accordance with this application without worsening their condition.

The aligner according to the present application can be produced in two ways:
1. With the use of appropriate software, with a platform on the occlusal side in one of the arches, so when the planning is completed, the device is already made with the platform (3);
2. In an additional embodiment where the platform (3) is located on both arcades, so one slides over the other.

The aligner pursuant to this application may be made of acetate, polyurethane, smart track (a registered trademark of Invisilaign), or any other compatible material.

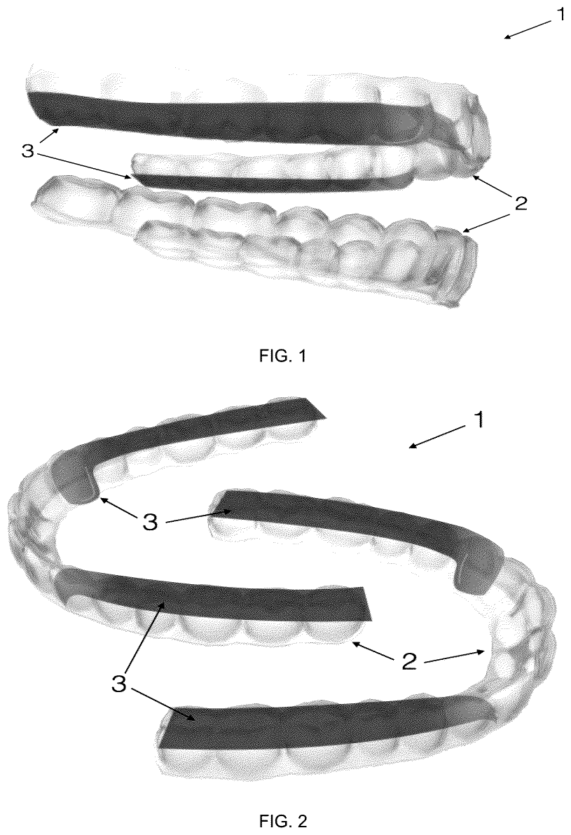

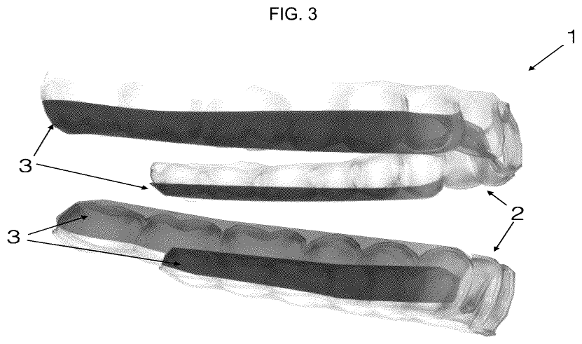

FIG. 1 shows that the aligner (1) involves all the faces of the buccal, lingual teeth, and that it has, on the occlusal face (2), a modification designed that leaves the face flat (3) in one of the arches or in both, depending on of the case.

The occlusal contact occurs as illustrated in FIG. 1 and in a first modality, the aligner (1), when the flat face (3) is in the upper arch, has contacts that occur with the buccal cusp tip of the lower and in that, in the region of the canine tooth, there is a ramp where canine and anterior guide contacts are located, whenever possible.

As illustrated in FIG. 1, in one embodiment, the aligner (1), when the flat face (3) is on the lower one, the occlusal contacts will be on the lingual cusp tip of the upper ones. In the canine region there is a ramp to provide canine and anterior guidance whenever possible.

As illustrated in FIG. 1, in one embodiment, the aligner (1) makes use of the platforms (3) on the upper and lower apparatus and, if possible, the canine and anterior guide.

Although the present application has been described with respect to a preferred embodiment, it should be realized that many variations, modifications, equivalent structural elements, combinations, sub-combinations and other applications of the present disclosure can be made and do not depart from the scope of protection of the present disclosure.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An orthodontic aligner, wherein one side of the orthodontic aligner is flat and the other side comprises an arch that has a shape of teeth, in which there is a ramp in a canine region (canine guide) to direct laterality and anterior guidance movements, when possible.

2. The orthodontic aligner according to claim 1, wherein in both arches an occlusal surface thereof is flat and, in the canine region, there is a canine and anterior guide.
